(19) United States
(12) Patent Application Publication
(10) Pub. No.: US 2025/0210871 A1
(43) Pub. Date: Jun. 26, 2025

(54) ANTENNA ELEMENT, ANTENNA SUBSTRATE, AND ANTENNA MODULE

(71) Applicant: KYOCERA Corporation, Kyoto-shi, Kyoto (JP)

(72) Inventor: Satoshi ASAI, Kirishima-shi (JP)

(73) Assignee: KYOCERA Corporation, Kyoto-shi, Kyoto (JP)

(21) Appl. No.: 18/851,956

(22) PCT Filed: Mar. 27, 2023
(86) PCT No.: PCT/JP2023/012098

§ 371 Date: Sep. 27, 2024

(30) Foreign Application Priority Data
Mar. 29, 2022 (JP) 2022-052701

(51) Int. Cl. H01Q 13/08; H01Q 21/00; H01Q 23/00

(52) U.S. Cl. CPC H01Q 13/08; H01Q 21/0068; H01Q 23/00

(57) ABSTRACT

An antenna element includes a first dielectric, a second dielectric, a ground conductor, a feed conductor plate, and a nonfeed conductor plate. The ground conductor, the feed conductor plate, and the nonfeed conductor plate are positioned in a mentioned order. The ground conductor and the feed conductor plate face each other to interpose the first dielectric. The feed conductor plate and the nonfeed conductor plate face each other to interpose the second dielectric. The antenna element further includes a projecting conductor projecting from the feed conductor plate toward the ground conductor.

### TECHNICAL FIELD

The present disclosure relates to an antenna element, an antenna substrate, and an antenna module.

### BACKGROUND OF INVENTION

Patent Literature 1 discloses, as a broadband antenna element, a microstrip antenna including a conductor plate and a ground conductor facing each other to interpose a dielectric.

### CITATION LIST

### Patent Literature

Patent Literature 1: Japanese Unexamined Patent Application Publication No. 55-93305

### SUMMARY

### Problem to be Solved

Antennas have been demanded to have wider band characteristics in recent years. The present disclosure provides an antenna element, an antenna substrate, and an antenna module that have wider band characteristics.

### Solution to Problem

The present disclosure provides an antenna element including a first dielectric, a second dielectric, a ground conductor, a feed conductor plate, and a nonfeed conductor plate. The ground conductor, the feed conductor plate, and the nonfeed conductor plate are positioned in a mentioned order. The ground conductor and the feed conductor plate face each other to interpose the first dielectric. The feed conductor plate and the nonfeed conductor plate face each other to interpose the second dielectric. The antenna element further includes a projecting conductor projecting from the feed conductor plate toward the ground conductor.

The present disclosure provides an antenna substrate including a plurality of antenna elements, and each of the plurality of antenna elements is the antenna element

The present disclosure provides an antenna module including the antenna substrate and an integrated circuit.

### Advantageous Effect

The present disclosure can provide an antenna element, an antenna substrate, and an antenna module that have wider band characteristics.

### BRIEF DESCRIPTION OF THE DRAWINGS

FIG. 1A is a perspective view of an antenna element according to embodiment 1 of the present disclosure.

FIG. 1B is a plan view of the antenna element according to embodiment 1 of the present disclosure.

FIG. 2A is a longitudinal sectional view taken along line A-A in FIG. 1B.

FIG. 2B is a longitudinal sectional view taken along line B-B in FIG. 1B.

FIG. 3 is a graph indicating return losses of the antenna element according to embodiment 1 and antenna elements according to comparative examples 1 to 3.

FIG. 4A is a view according to variation 1 in a case where a projecting conductor is displaced in a direction perpendicular to a resonant direction.

FIG. 4B is a view according to variation 2 in another case where the projecting conductor is displaced in the direction perpendicular to the resonant direction.

FIG. 4C is a view according to variation 3 in still another case where the projecting conductor is displaced in the direction perpendicular to the resonant direction.

FIG. 4D is a view according to variation 4 in further another case where the projecting conductor is displaced in the direction perpendicular to the resonant direction.

FIG. 5 is a graph indicating return losses of antenna elements according to variations 1 to 4.

FIG. 6A is a view according to variation 5 in a case where projecting conductors are displaced in the resonant direction.

FIG. 6B is a view according to variation 6 in another case where the projecting conductors are displaced in the resonant direction.

FIG. 6C is a view according to variation 7 in still another case where the projecting conductors are displaced in the resonant direction.

FIG. 7A is a graph indicating a relationship between a position of each of the projecting conductors in the resonant direction and a pole frequency, specifically indicating a relationship between the position and a lower pole frequency.

FIG. 7B is a graph indicating a relationship between the position of each of the projecting conductors in the resonant direction and the pole frequency, specifically indicating a relationship between the position and a higher pole frequency.

FIG. 7C is a graph indicating a relationship between the position of each of the projecting conductors in the resonant direction and the pole frequency, specifically indicating a relationship between the position and a bandwidth between the two pole frequencies.

FIG. 8A is a plan view of an antenna element according to embodiment 2.

FIG. 8B is a perspective view of the antenna element according to embodiment 2.

FIG. 8C is a longitudinal sectional view of the antenna element according to embodiment 2.

FIG. 9 is a graph indicating a relationship between a width of a plate-shaped body and the lower pole frequency.

FIG. 10A is a view according to variation 8 of embodiment 2.

FIG. 10B is a view according to variation 9 of embodiment 2.

FIG. 10C is a view according to variation 10 of embodiment 2.

FIG. 11 is a graph indicating return losses of antenna elements according to variations 8 to 10.

FIG. 12A is a perspective view of an antenna substrate and an antenna module according to an embodiment of the present disclosure.

FIG. 12B is a longitudinal sectional view of the antenna substrate and the antenna module according to the embodiment of the present disclosure.

### DESCRIPTION OF EMBODIMENTS

Embodiments of the present disclosure will be described in detail hereinafter with reference to the drawings.

### Embodiment 1

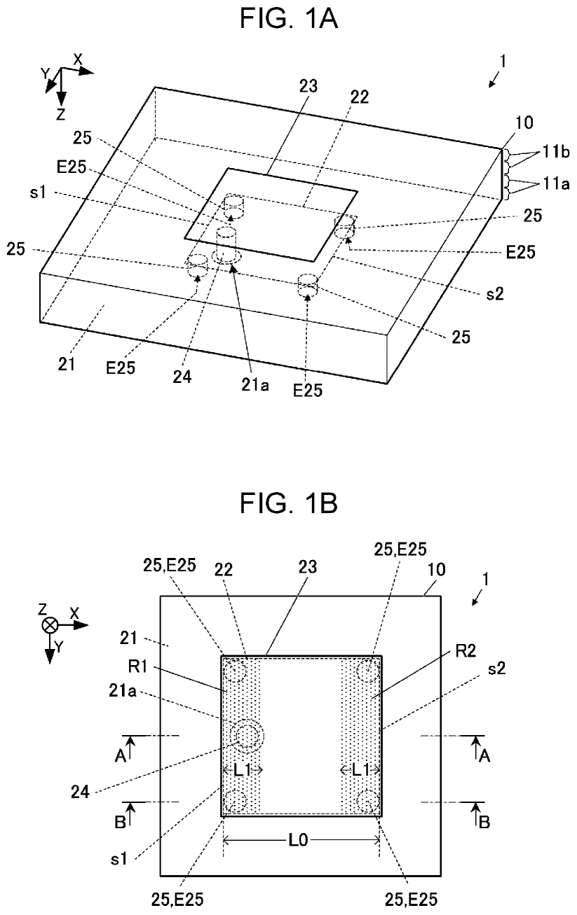

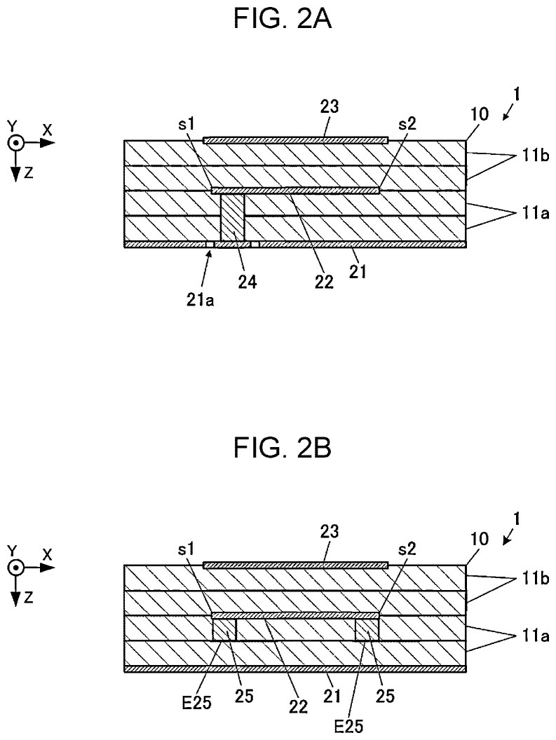

FIG. 1A is a perspective view of an antenna element according to embodiment 1 of the present disclosure. FIG. 1B is a plan view of the antenna element according to embodiment 1 of the present disclosure. FIG. 2A is a longitudinal sectional view taken along line A-A in FIG. 1B. FIG. 2B is a longitudinal sectional view taken along line B-B in FIG. 1B. The drawings will hereinafter assume that a Z direction and X and Y directions perpendicular to the Z direction correspond to a vertically downward direction and a horizontal direction, respectively. The Z direction corresponds to a direction perpendicular to an upper surface of a feed conductor plate 22, and the X and Y directions correspond to directions along the upper surface of the feed conductor plate 22 and perpendicular to each other. The present description refers to directions of up, down, left, and right that may be different from directions of up, down, left, and right of an antenna element 1 in use.

In embodiment 1, the antenna element 1 includes a dielectric substrate 10, as well as the feed conductor plate 22, a nonfeed conductor plate 23, a ground conductor 21, a feed conductor 24, and a projecting conductor 25 that are positioned on or in the dielectric substrate 10.

The ground conductor 21, the feed conductor plate 22, and the nonfeed conductor plate 23 are positioned in the mentioned order. The ground conductor 21 and the feed conductor plate 22 face each other to interpose part of layers of the dielectric substrate 10 (i.e., a dielectric layer 11a serving as a first dielectric). The feed conductor plate 22 and the nonfeed conductor plate 23 face each other to interpose part of the layers of the dielectric substrate 10 (i.e., a dielectric layer 11b serving as a second dielectric).

In a plan perspective view, the ground conductor 21 may be larger in area than the feed conductor plate 22 and the nonfeed conductor plate 23. In a plan perspective view, the feed conductor plate 22 and the nonfeed conductor plate 23 may each have a rectangular shape. Plan perspective view means perspectively viewing in a downward direction.

The feed conductor 24 is connected to the feed conductor plate 22. The feed conductor 24 may be connected to the feed conductor plate 22 at a position displaced in a direction from a center of the feed conductor plate 22. In FIGS. 1 and 2, the feed conductor 24 is connected to the feed conductor plate 22 at a position displaced in the X direction from the center of the feed conductor plate 22. The feed conductor 24 may extend from below the ground conductor 21 to the feed conductor plate 22 via a through-hole 21a provided in the ground conductor 21. The feed conductor 24 may transmit electric power according to a transmission signal to the feed conductor plate 22. Alternatively, the feed conductor 24 may transmit a signal received by the antenna element 1.

The dielectric substrate 10 may be made of a ceramic such as an aluminum oxide sintered body, a glass ceramic sintered body, a mullite sintered body, or an aluminum nitride sintered body, or a resin. The dielectric substrate 10 may have a stacked structure including a plurality of (e.g., four) dielectric layers 11a and 11b. The ground conductor 21 may be positioned on a lower surface of the lower one of the dielectric layers 11a, the feed conductor plate 22 may be positioned between intermediate two of the dielectric layers 11a and 11b, and the nonfeed conductor plate 23 may be positioned on an upper surface of the uppermost one of the dielectric layers 11b. A dielectric layer may further be provided below the ground conductor 21.

Each of the feed conductor plate 22 and the nonfeed conductor plate 23 may be a metallized conductor film. Each of the feed conductor 24 and the projecting conductor 25 may be a via conductor solidified upon burning the dielectric substrate 10. In a case where the dielectric substrate 10 is a resin substrate, each of the feed conductor plate 22 and the nonfeed conductor plate 23 may be copper foil and each of the feed conductor 24 and the projecting conductor 25 may be a conductor as a via hole filled by plating in the resin substrate.

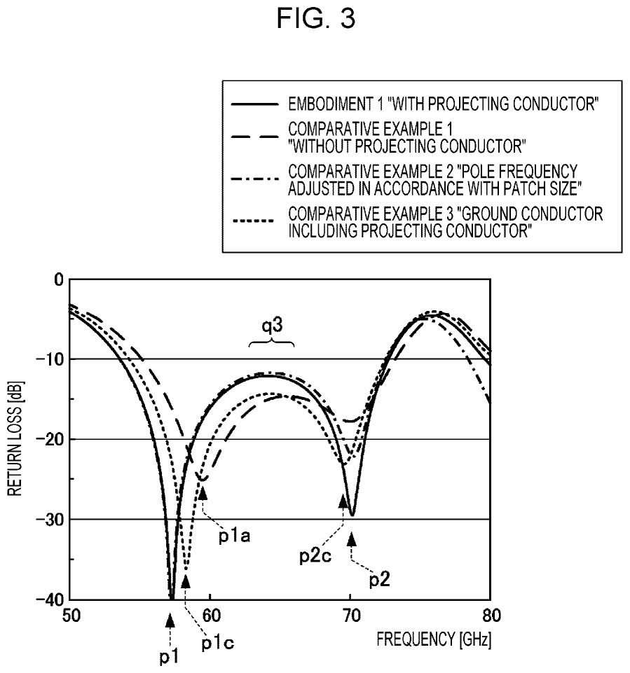

In the antenna element 1 thus configured, when high frequency power is fed to the feed conductor plate 22 via the feed conductor 24, the feed conductor plate 22 generates resonance and outputs a radio wave. Furthermore, electric field vibration propagates from the feed conductor plate 22 to the nonfeed conductor plate 23 to generate resonance of the nonfeed conductor plate 23 that outputs a radio wave. The nonfeed conductor plate 23 is set to be higher in resonance frequency than the feed conductor plate 22. As illustrated in FIG. 3, such setting enables broadband characteristics with a small loss in a peripheral band of a lower pole frequency p1 (see FIG. 3) corresponding to the resonance frequency of the feed conductor plate 22, a peripheral band of a higher pole frequency p2 (see FIG. 3) corresponding to the resonance frequency of the nonfeed conductor plate 23, and a band between the pole frequencies p1 and p2.

### <Projecting Conductor>

The projecting conductor 25 projects from the feed conductor plate 22 toward the ground conductor 21. The projecting conductor may project in the Z direction (i.e., a vertical direction) or in a direction containing any one or both of components of the X direction and the Y direction as long as the direction contains a component of the Z direction. The projecting conductor 25 may be a rod-shaped body extending in the projecting direction such as a circular columnar-shaped body or a polygonal columnar-shaped body. The projecting conductor 25 may be shaped with no change in thickness in the projecting direction or may be shaped to be tapered, broaden, or the like with a change in thickness. The projecting conductor 25 may extend linearly in the vertical direction, or may have a portion bent into the horizontal direction. The projecting conductor 25 having the circular columnar-shape and extending linearly facilitates a forming process of the projecting conductor 25 as well as achieves dispersion of stress distribution between the projecting conductor 25 and the dielectric substrate 10 to improve strength around the projecting conductor 25.

The projecting conductor 25 may be identical or different in transverse sectional shape and dimension to or from the feed conductor 24. In the case where the transverse sectional shape and dimension are identical, the projecting conductor 25 and the feed conductor 24 are easily formed in a common process. A transverse section means a section in the horizontal direction.

The projecting conductor 25 may have any length (i.e., a dimension in the vertical direction) unless otherwise being in contact with the ground conductor 21. The length of the projecting conductor 25 may be one-fourth or more of a distance between the feed conductor plate 22 and the ground conductor 21 (i.e., a length between opposing surfaces). Such a length improves a function of increasing electrostatic capacitance of the feed conductor plate 22 to be described later. In the case where the dielectric substrate 10 has the stacked structure, a tip of the projecting conductor 25 may be positioned between the dielectric layers 11a. In an exemplary case where the ground conductor 21 and the feed conductor plate 22 interpose two dielectric layers 11a equal in thickness, the projecting conductor 25 may have a length corresponding to a half of an interval between the ground conductor 21 and the feed conductor plate 22. The projecting conductor 25 having the tip positioned between the plurality of dielectric layers 11a facilitates the forming process of the projecting conductor 25.

The projecting conductor 25 may include a surface positioned at an end adjacent to the ground conductor 21, that is, an end surface E25. The end surface E25 may be parallel to or inclined from an upper surface of the ground conductor 21. The end surface E25 thus provided can store electric charge and improves the function of increasing electrostatic capacitance of the feed conductor plate 22 to be described later. The end surface E25 of the projecting conductor 25 indicates a surface of the projecting conductor 25 appearing in a-Z direction (i.e., upward) from the ground conductor 21 assuming that the dielectric substrate 10 is transparent, and an axis in the Z direction and a perpendicular line of the surface form an acute angle less than 30 degrees. The end surface E25 includes a center indicating an intersection point of a straight line equally halving an area of the end surface E25 in the X direction in a plan perspective view with a straight line equally halving the area in the Y direction. The X direction herein is assumed as a direction of a line segment connecting an edge of the feed conductor plate 22 and the feed conductor 24 so as to have a minimum distance. In a case where the end surface E25 includes a plurality of discontinuous end surfaces, assume that the center of the end surface E25 is positioned in each of the plurality of end surfaces and is defined in accordance with each of the end surfaces.

The antenna element 1 may include a plurality of projecting conductors 25. The plurality of projecting conductors 25 has an interval that may be equal to or more than the thickness (i.e., a transverse width) of each of the projecting conductors 25. The interval thus provided keeps strength of a portion of the dielectric substrate 10 positioned between the plurality of projecting conductors 25.

In a plan perspective view, the end surface E25 of the projecting conductor 25 may be positioned not to protrude outward from the feed conductor plate 22 (see FIG. 1B). In other words, in a plan perspective view, the end surface E25 of the projecting conductor 25 may entirely be positioned within a region surrounded with an outer edge of the feed conductor plate 22. Herein, the region surrounded with the outer edge of the feed conductor plate 22 conforms to a region occupied by the feed conductor plate 22 including no cutout such as a slit, and corresponds to a region obtained by combining the feed conductor plate 22 including any cutout such as a slit and the cutout. As to be described later in a section “Protrusion of plate-shaped body”, this configuration achieves wider band characteristics with a lower return loss.

The feed conductor 24 may be connected to the feed conductor plate 22 at a position displaced from the center of the feed conductor plate 22. The feed conductor plate 22 has resonance generated in a direction connecting a center point of the feed conductor plate 22 and a center of a position (i.e., a feed point) connected to the feed conductor 24. In FIGS. 1A, 1B, 2A, and 2B, the feed conductor 24 is connected to the feed conductor plate 22 at the position displaced in the X direction from the center of the feed conductor plate 22. Accordingly, the X direction corresponds to the resonant direction of the feed conductor plate 22, and the Y direction corresponds to a direction perpendicular to the resonant direction. In a plan perspective view, the feed conductor plate 22 may include a first side s1 and a second side s2 crossing (e.g., substantially perpendicular to) the resonant direction. The first side s1 is positioned closer to the feed conductor 24 in comparison to the second side s2.

In a plan perspective view, the center of the end surface E25 of the projecting conductor 25 may be positioned in at least one of regions R1 and R2 indicated in FIG. 1B. The regions R1 and R2 are hatched in FIG. 1B. The region R1 corresponds to a region inside the feed conductor plate 22 from the first side s1 and within a distance L1 from the first side s1. The region R2 corresponds to a region inside the feed conductor plate 22 from the second side s2 and within the distance L1 from the second side s2. The distance L1 is times an effective wavelength A corresponding to a maximum frequency in a transmission frequency band. The distance L1 may also be expressed as one-fourth of a dimension L0 in the X direction of the feed conductor plate 22. As to be described later in a section “disposition of projecting conductor in resonant direction”, this configuration achieves a wider band of antenna characteristics.

As illustrated in FIG. 1B, the antenna element 1 may include four projecting conductors 25 that may be positioned respectively in four nook portions of the feed conductor plate 22 in a plan perspective view. Herein, the nook portions may indicate regions including corners of the feed conductor plate 22 among regions obtained by equally quartering the feed conductor plate 22 in the X direction and equally quartering the feed conductor plate 22 in the Y direction. The interval between the plurality of projecting conductors 25 can be increased in this configuration so as to reduce weak portions in the dielectric substrate 10. Furthermore, the projecting conductors 25 are positioned in both of the regions R1 and R2 to achieve a significantly wider band of the antenna characteristics.

### <Function of Projecting Conductor>

FIG. 3 is a graph indicating return losses of the antenna element according to embodiment 1 and antenna elements according to comparative examples 1 to 3. The return losses indicated in FIG. 3 are simulation results.

The projecting conductor 25 has a function of increasing electrostatic capacitance between the feed conductor plate 22 and the ground conductor 21 without any change in the dimension of the feed conductor plate 22 in a plan perspective view. The resonance frequency of the feed conductor plate 22 is thus decreased in comparison to a case where the projecting conductor 25 is not provided. The projecting conductor 25 does not largely influence the resonance frequency of the nonfeed conductor plate 23. Accordingly, the lower pole frequency p1 of the antenna element 1 can be decreased without changing the higher pole frequency p2, so as to achieve a wider band of the antenna characteristics.

Comparative example 1 in FIG. 3 exhibits characteristics of a configuration identical to the configuration of the antenna element 1 according to embodiment 1 except for no provision of the projecting conductor 25. As indicated by comparison between the characteristics of comparative example 1 and the characteristics of embodiment 1, the lower pole frequency p1 of the case where the projecting conductor 25 is provided is lower than a pole frequency p1a of the case where the projecting conductor 25 is not provided. Meanwhile, the higher pole frequency p2 does not change significantly. Embodiment 1 thus achieves a wider band.

Comparative example 2 in FIG. 3 exhibits characteristics of the case where the lower pole frequency p1 is adjusted by a patch size. The patch size means sizes of the feed conductor plate 22 and the nonfeed conductor plate 23. According to comparative example 2, the feed conductor plate 22 is adjusted in size. As indicated by comparison between the characteristics of comparative example 2 and the characteristics of embodiment 1, the feed conductor plate 22 is adjusted in size to substantially equalize the lower pole frequency p1 to the value according to embodiment 1. However, when the lower pole frequency p1 is adjusted by the patch size, the feed conductor plate 22 between the nonfeed conductor plate 23 and the ground conductor 21 is relatively changed in area. This influences the electrostatic capacitance between the nonfeed conductor plate 23 and the ground conductor 21 to increase a return loss around the higher pole frequency p2. In the case where the lower pole frequency p1 is decreased by the projecting conductor 25 as in embodiment 1, there is no restriction on the area of the feed conductor plate 22. The area of the feed conductor plate 22 can thus be set to achieve preferred characteristics of the feed conductor plate 22 and the nonfeed conductor plate 23. Embodiment 1 can therefore achieve wider band characteristics as well as a decrease in the return loss of the higher pole frequency p2 for high antenna gain.

Comparative example 3 in FIG. 3 exhibits characteristics of a configuration in which a projecting conductor is provided not on the feed conductor plate 22 but on the ground conductor 21. In the configuration according to comparative example 3, the ground conductor 21 includes a projecting conductor projecting toward the feed conductor plate 22 that does not include the projecting conductor 25. The remaining configuration is the same or a similar to the configuration according to embodiment 1. As indicated by comparison between the characteristics of comparative example 3 and the characteristics of embodiment 1, the projecting conductor on the ground conductor 21 increases the electrostatic capacitance of the feed conductor plate 22 as well as increases electrostatic capacitance of the nonfeed conductor plate 23. This deceases a higher pole frequency p2c to reduce the function of a wider band. The projecting conductor 25 provided on the feed conductor plate 22 as in embodiment 1 can decrease the lower pole frequency p1 with small influence on the higher pole frequency p2. This achieves a wider band of the antenna characteristics.

### <Disposition of Projecting Conductor in Direction Perpendicular to Resonant Direction>

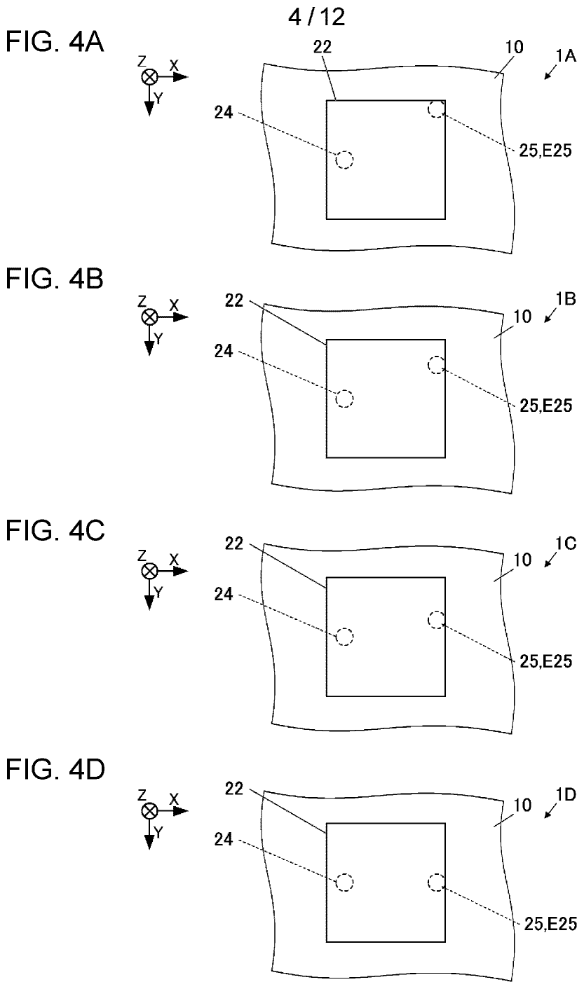

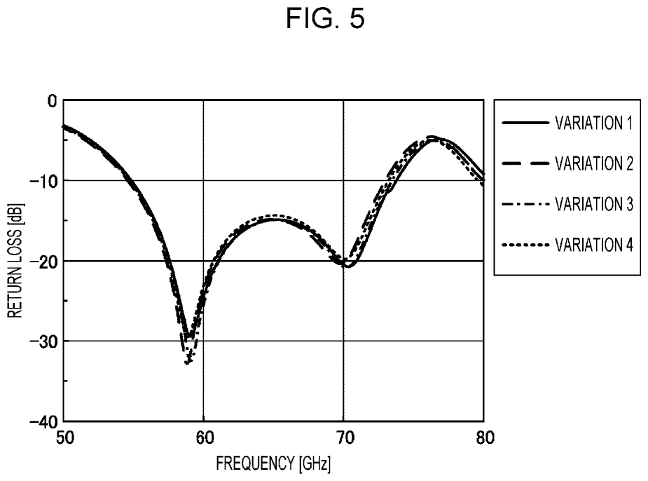

FIGS. 4A to 4D are views according to variations 1 to 4 in cases where the projecting conductor is displaced in the direction perpendicular to the resonant direction. FIGS. 4A to 4D do not illustrate constituent elements positioned above the feed conductor plate 22. In these figures, the Y direction corresponds to the direction perpendicular to the resonant direction. FIG. 5 is a graph indicating return losses of antenna elements according to variations 1 to 4. FIG. 5 indicates simulation results.

As described above, the feed conductor 24 may be connected to the feed conductor plate 22 at a position displaced from the center of the feed conductor plate 22. The feed conductor plate 22 has resonance generated in the direction connecting the center point of the feed conductor plate 22 and the center of the position (i.e., the feed point) connected to the feed conductor 24. In FIGS. 4A to 4D, the X direction corresponds to the resonant direction of the feed conductor plate 22, and the Y direction corresponds to the direction perpendicular to the resonant direction.

Variations 1 to 4 of the present embodiment provide antenna elements 1A to 1D configured identically or similarly to embodiment 1 except for the number and disposition of the projecting conductors 25. The antenna elements 1A to 1D each include a single projecting conductor 25. The projecting conductors 25 are identical in dimension, shape, and position in the X direction.

In variation 1, the projecting conductor 25 is positioned at an end in the Y direction of the feed conductor plate 22 in a plan perspective view. In each of variations 2 and 3, the projecting conductor 25 is positioned between a center and the end in the Y direction of the feed conductor plate 22 in a plan perspective view. In variation 4, the projecting conductor 25 is positioned at the center in the Y direction of the feed conductor plate 22 in a plan perspective view.

In variations 1 to 4, the antenna elements 1A to 1D have return losses of equal or similar characteristics as indicated in FIG. 5. Results in FIG. 5 lead to a fact that a wider band of the antenna characteristics can be achieved even when the projecting conductor 25 is positioned differently in the direction perpendicular to the resonant direction (i.e., the Y direction).

Regarding the position of the projecting conductor 25, the antenna characteristics are influenced mainly by the position of the end surface E25 adjacent to the ground conductor 21 of the projecting conductor 25 and a position of the projecting conductor 25 connected to the feed conductor plate 22. The fact derived from FIG. 5 may thus also be expressed in the following manner. A wider band of the antenna characteristics can be achieved even when the end surface E25 adjacent to the ground conductor 21 of the projecting conductor 25 is positioned differently in the direction perpendicular to the resonant direction inside the feed conductor plate 22 in a plan perspective view. Alternatively, a wider band of the antenna characteristics can be achieved even when the position of the projecting conductor 25 connected to the feed conductor plate 22 is different in the direction perpendicular to the resonant direction.

### <Disposition of Projecting Conductor in Resonant Direction>

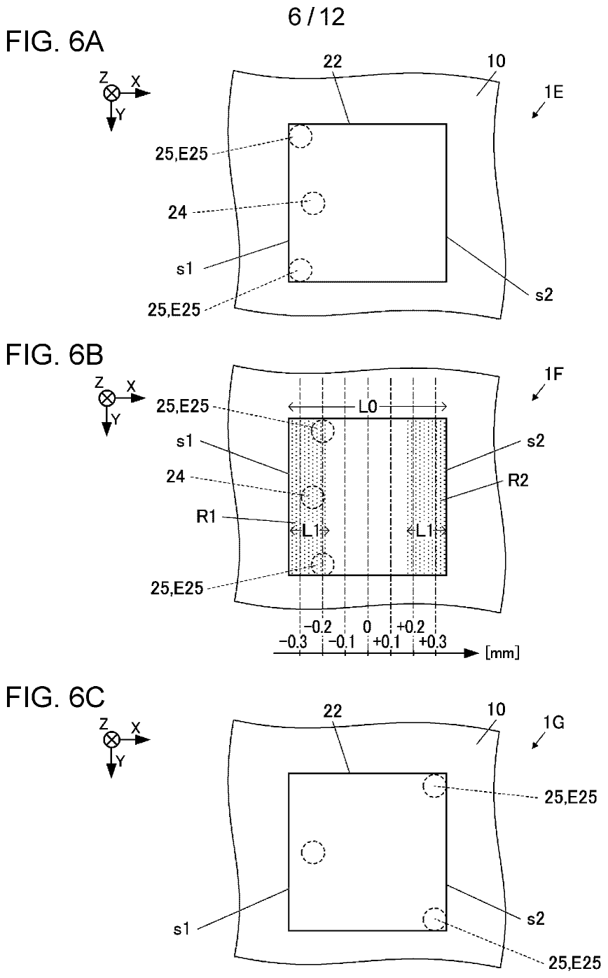

FIGS. 6A to 6C are views according to variations 5 to 7 in cases where the projecting conductors are displaced in the resonant direction. FIGS. 6A to 6C do not illustrate constituent elements positioned above the feed conductor plate 22. In these figures, the X direction corresponds to the resonant direction.

As described above, in a plan perspective view, the feed conductor plate 22 may include the first side s1 and the second side s2 crossing (e.g., substantially perpendicular to) the resonant direction. The first side s1 is positioned closer to the feed conductor 24 in comparison to the second side s2.

Variations 5 to 7 of the present embodiment provide antenna elements 1E to 1G configured identically or similarly to embodiment 1 except for the number and disposition of the projecting conductors 25. The antenna elements 1E to 1G each include two projecting conductors 25. All the projecting conductors 25 are identical in dimension and shape. In each of the antenna elements 1E to 1G, the two projecting conductors 25 are positioned at respective ends in the Y direction.

The dimension of the feed conductor plate 22 may be set in proportion to the effective wavelength (i.e., a wavelength in a dielectric) λ in a transmission frequency band of each of the antenna elements 1E to 1G. In the present embodiment, the maximum frequency in the transmission frequency band is 71 [GHz], the dielectric substrate 10 has a relative dielectric constant equal to 5.7, the effective wavelength λ is 1.77 [mm], and the dimension of the feed conductor plate 22 in the X direction is 0.7 [mm].

In FIG. 6A, the two projecting conductors 25 are positioned at an end (i.e., an end closer to the feed conductor 24) in the X direction of the feed conductor plate 22 in a plan perspective view. Such positions correspond to a position of −0.3 [mm] (see FIG. 6B) in the X direction from the center of the feed conductor plate 22 serving as an origin. Herein and hereinafter, the position of each of the projecting conductors 25 is expressed as a position of a center point of the projecting conductor 25.

In FIG. 6B, the two projecting conductors 25 are each disposed at an intermediate position in the X direction of the feed conductor plate 22 in a plan perspective view. Such positions correspond to a position of −0.2 [mm] in the X direction from the center of the feed conductor plate 22 serving as the origin.

In FIG. 6C, the two projecting conductors 25 are positioned at an opposite end (i.e., an end far from the feed conductor 24) in the X direction of the feed conductor plate 22 in a plan perspective view. Such positions correspond to a position of +0.3 [mm] (see FIG. 6B) in the X direction from the center of the feed conductor plate 22 serving as the origin.

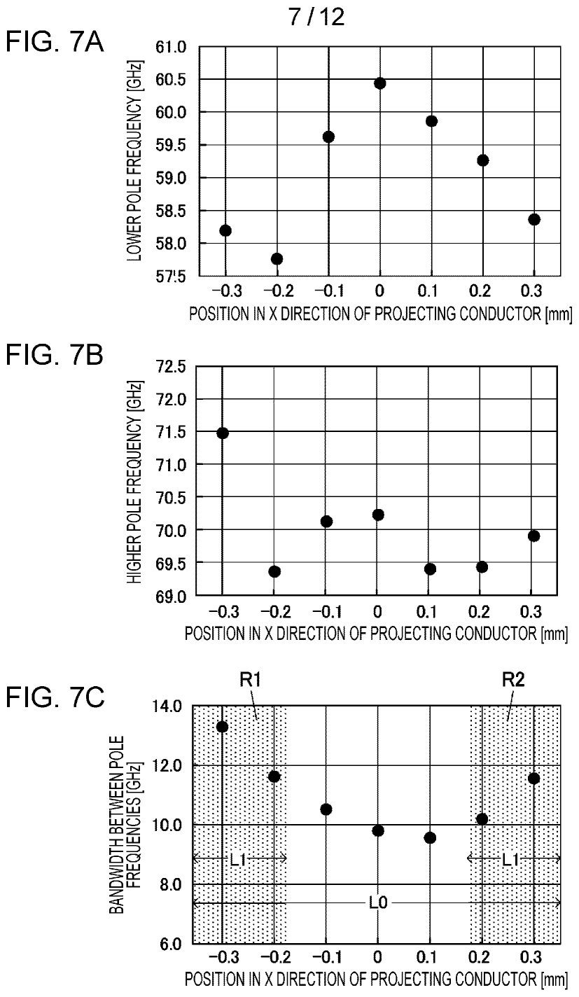

FIGS. 7A to 7C are graphs each indicating a relationship between the position of each of the projecting conductors in the resonant direction and the pole frequency. FIG. 7A indicates a relationship between the position and the lower pole frequency, FIG. 7B indicates a relationship between the position and the higher pole frequency, and FIG. 7C indicates a relationship between the position and a bandwidth between the two pole frequencies. The pole frequencies in FIGS. 7A and 7B are extracted from obtained characteristic lines of frequency characteristics of the return losses obtained through simulation for the antenna elements 1E to 1G according to variations 5 to 7 and a plurality of additional antenna elements. In each of the additional antenna elements, the two projecting conductors 25 are positioned at −0.1 [mm], 0 [mm], +0.1 [mm], and +0.2 [mm] (see FIG. 6B) in the X direction. The bandwidth between the pole frequencies in FIG. 7C indicates a value obtained by subtracting the lower pole frequency from the higher pole frequency.

The antenna characteristics can achieve a wider band by widening the two pole frequencies (see the pole frequencies p1 and p2 in FIG. 3) of the return loss. As indicated in FIG. 7C, the position in the X direction of the projecting conductors 25 and the bandwidth between the pole frequencies are correlated with each other. The results in FIG. 7C lead to a fact that the antenna characteristics can achieve a wider band when the centers of the projecting conductors 25 are positioned in any one of the regions R1 and R2 (see FIGS. 6B and 7C). The regions R1 and R2 are hatched in FIGS. 6B and 7C.

The region R1 corresponds to the region inside the feed conductor plate 22 from the first side s1 and within the distance L1 from the first side s1. The region R2 corresponds to the region inside the feed conductor plate 22 from the second side s2 and within the distance L1 from the second side s2. The distance L1 is 0.1 times the effective wavelength A corresponding to the maximum frequency in the transmission frequency band. The distance L1 may also be expressed as one-fourth of the dimension L0 in the X direction of the feed conductor plate 22.

Regarding the position of each of the projecting conductors 25, the antenna characteristics are influenced mainly by the position of the end surface E25 adjacent to the ground conductor 21 of the projecting conductor 25 and the position of the projecting conductor 25 connected to the feed conductor plate 22. The fact derived from FIG. 7C may thus also be expressed in the following manner. In a plan perspective view, the antenna characteristics can achieve a wider band when the center of the end surface E25 adjacent to the ground conductor 21 of each of the projecting conductors 25 is positioned in any one of the regions R1 and R2. Alternatively, the antenna characteristics can achieve a wider band when the center of the position connected to the feed conductor plate 22 of each of the projecting conductors 25 is positioned in any one of the regions R1 and R2.

### Embodiment 2

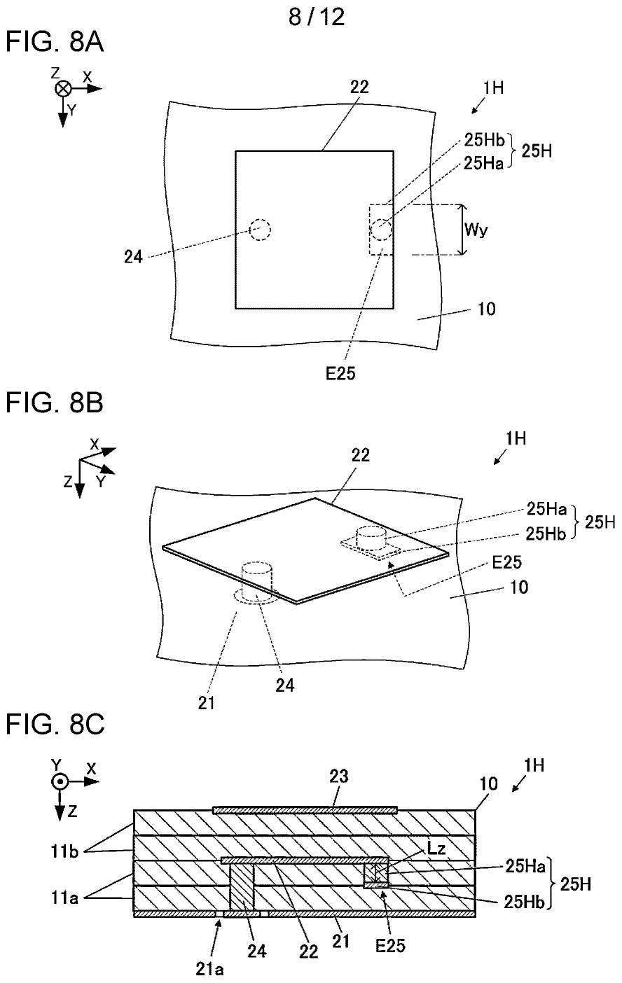

FIG. 8A is a plan view of an antenna element according to embodiment 2. FIG. 8B is a perspective view of the antenna element according to embodiment 2. FIG. 8C is a longitudinal sectional view of the antenna element according to embodiment 2. FIGS. 8A and 8B do not illustrate configurations positioned above the feed conductor plate 22. Embodiment 2 provides an antenna element 1H that is configured identically or similarly to embodiment 1 except for a different shape of a projecting conductor 25H.

The projecting conductor 25H includes a rod-shaped body 25Ha extending from the feed conductor plate 22 toward the ground conductor 21, and a plate-shaped body 25Hb connected to the rod-shaped body 25Ha and expanding in a direction crossing a projecting direction of the projecting conductor 25H. The rod-shaped body 25Ha may alternatively extend in a direction perpendicular to a plate surface of the feed conductor plate 22. The plate-shaped body 25Hb may be connected to a tip of the rod-shaped body 25Ha. In this configuration, the projecting conductor 25H includes an end surface E25 corresponding to a lower surface (i.e., a plate surface adjacent to the ground conductor 21) of the plate-shaped body 25Hb. The plate-shaped body 25Hb may alternatively expand along the upper surface of the ground conductor 21.

The plate-shaped body 25Hb may be a metallized conductor film. The rod-shaped body 25Ha may be a via conductor solidified upon burning the dielectric substrate 10. Alternatively, in a case where the dielectric substrate 10 is a resin substrate, the plate-shaped body 25Hb may be copper foil and the rod-shaped body 25Ha may be a conductor as a via hole filled by plating in the resin substrate. The rod-shaped body 25Ha may be configured identically or similarly to the projecting conductor 25 according to embodiment 1. The plate-shaped body 25Hb may be positioned between the two dielectric layers 11a and 11a.

As illustrated in FIG. 8A, in the plate-shaped body 25Hb in a plan perspective view, a width in the X direction may be substantially equal to a diameter (a width in the X direction in a rectangular shape) of the rod-shaped body 25Ha, and a width in the Y direction may be larger than the diameter of the rod-shaped body 25Ha. Alternatively in the plate-shaped body 25Hb in a plan perspective view, the width in the X direction may be larger than the diameter of the rod-shaped body 25Ha and the width in the Y direction may be substantially equal to or larger than the diameter of the rod-shaped body 25Ha. An area of the plate-shaped body 25Hb in a plan perspective view (i.e., an area expanding in X-Y directions) may be larger than an area of an end surface of the rod-shaped body 25Ha in a plan perspective view.

### <Sizing of Plate-Shaped Body>

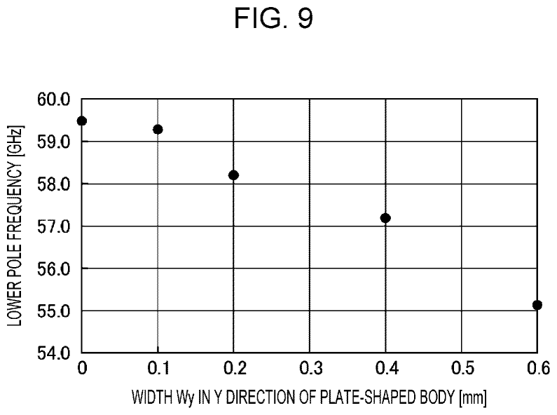

FIG. 9 is a graph indicating a relationship between the width of the plate-shaped body and the lower pole frequency.

A change in the width or the area of the plate-shaped body 25Hb leads to a change in the electrostatic capacitance between the ground conductor 21 and the feed conductor plate 22 and a change of the lower pole frequency p1 (see FIG. 3) of the return loss. FIG. 9 indicates the lower pole frequency obtained through simulation for each of antenna elements different in a width Wy (see FIG. 8A) in the Y direction of the plate-shaped body 25Hb and identical in remaining constituent elements. Results in FIG. 9 indicate that the lower pole frequency p1 decreases as the area of the plate-shaped body 25Hb increases so as to achieve a wider band of the antenna characteristics.

If the higher pole frequency p2 is substantially constant and the lower pole frequency p1 is too decreased in the characteristic line (see FIG. 3) of the return loss, an intermediate band q3 (see FIG. 3) between the two pole frequencies p1 and p2 has an increased bulge. This increases the return loss in the band q3.

Accordingly, the plate-shaped body 25Hb may be adjusted in size as long as the return loss in the band q3 has a desired value (e.g., −10 dB or less). Such adjustment achieves a wider band of the antenna characteristics with a desired gain also in the intermediate band q3.

### <Length of Rod-Shaped Body>

In a same or similar manner to the change in the width Wy of the plate-shaped body 25Hb, a change in a length Lz (see FIG. 8C) of the rod-shaped body 25Ha influences the characteristic line of the return loss. If the rod-shaped body 25Ha increases in length to reduce an interval between a tip of the projecting conductor 25H and the ground conductor 21, electrostatic capacitance between the ground conductor 21 and the feed conductor plate 22 is increased in a same or similar manner to a case where the width Wy of the plate-shaped body 25Hb is increased. The same or a similar applies to a configuration not including the plate-shaped body 25Hb (i.e., the configuration according to embodiment 1).

Accordingly, the length Lz (or the length of the projecting conductor 25 according to embodiment 1) of the rod-shaped body 25Ha may also be adjusted as long as the return loss in the intermediate band q3 has a desired value. Such adjustment achieves a wider band of the antenna characteristics with a desired gain also in the intermediate band q3.

### <Protrusion of Plate-Shaped Body>

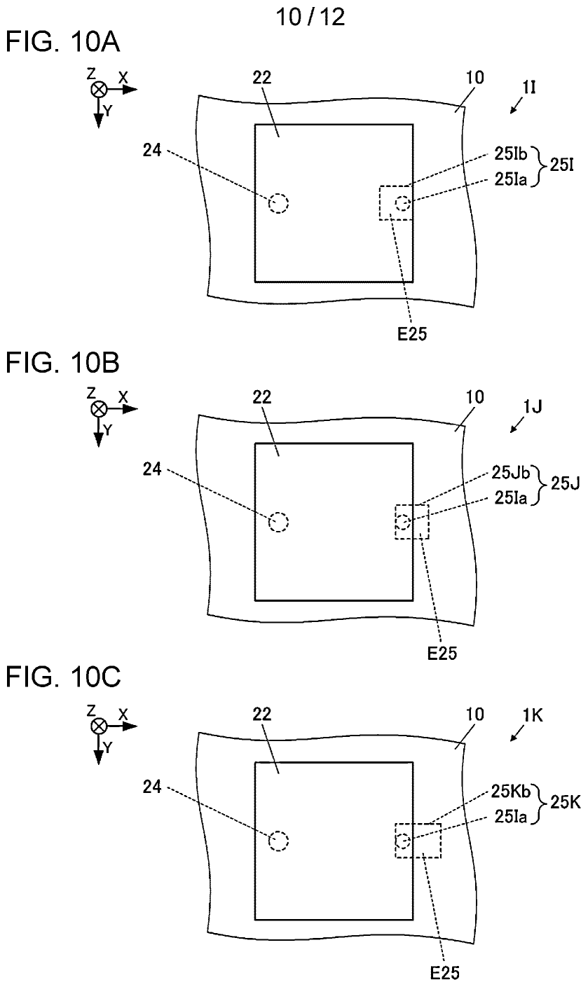

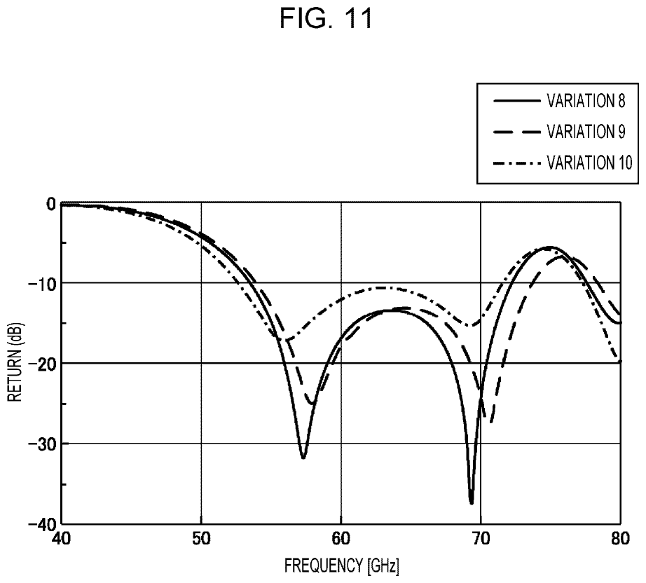

FIGS. 10A to 10C depict variations 8, 9, and 10 of embodiment 2, respectively. FIGS. 10A to 10C do not illustrate configurations positioned above the feed conductor plate 22. FIG. 11 is a graph indicating return losses of antenna elements according to variations 8 to 10.

Variation 8 provides an antenna element 1I configured identically or similarly to embodiment 2 except that a plate-shaped body 25Ib has a square shape in a plan perspective view. In a plan perspective view, the plate-shaped body 25Ib is entirely positioned within the region surrounded with the outer edge of the feed conductor plate 22.

In antenna elements 1J and 1K according to variations 9 and 10, in a plan perspective view, plate-shaped bodies 25Jb and 25Kb are partially positioned beyond the region surrounded with the outer edge of the feed conductor plate 22. The plate-shaped body 25Jb according to variation 9 is identical in shape and size to the plate-shaped body 25Ib according to variation 8. The plate-shaped body 25Kb according to variation 10 is larger in size than the plate-shaped body 25Ib according to variation 8, and is larger in the area (i.e., a protruding amount) positioned beyond the region surrounded with the outer edge of the feed conductor plate 22.

Results in FIG. 11 indicate that, in a plan perspective view, the plate-shaped body 25Ib (or the end surface E25 adjacent to the ground conductor 21 of a projecting conductor 25I) does not protrude from the feed conductor plate 22 to achieve a wider band of the antenna characteristics with a low return loss.

### <Connection Between Plate-Shaped Body and Plural Rod-Shaped Bodies>

When the width Wy of the plate-shaped body 25Hb in FIG. 8A increases, a plurality of rod-shaped bodies 25Ha can be connected to the single plate-shaped body 25Hb. However, connecting the plurality of rod-shaped bodies 25Ha spaced apart from each other to the single plate-shaped body 25Hb leads to formation of a looped current path connecting the feed conductor plate 22, a first one of the rod-shaped bodies 25Ha, the plate-shaped body 25Hb, and a second one of the rod-shaped bodies 25Ha. The looped current path influences a resonance mode of the feed conductor plate 22 to have difficulty in achieving a wider band of the antenna characteristics.

Therefore, the single rod-shaped body 25Ha may be connected to the single plate-shaped body 25Hb. This configuration achieves a wider band of the antenna characteristics.

### (Antenna Substrate and Antenna Module)

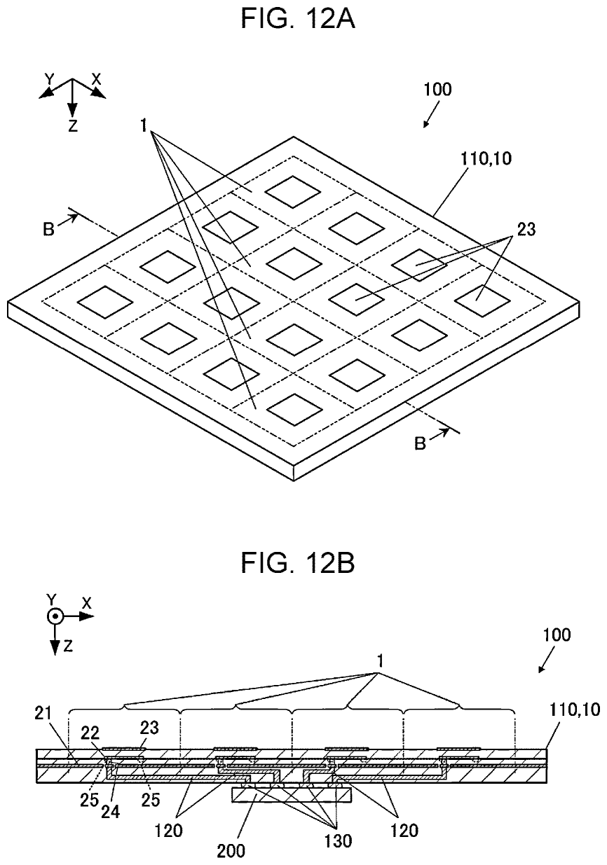

FIG. 12A is a perspective view of an antenna substrate and an antenna module according to an embodiment of the present disclosure. FIG. 12B is a longitudinal sectional view of the antenna substrate and the antenna module according to the embodiment of the present disclosure. FIG. 12B illustrates a section taken along line B-B in FIG. 12A.

The present embodiment provides an antenna substrate 110 including a plurality of antenna elements 1. The antenna elements 1 each correspond to the antenna element 1 according to embodiment 1, and may be replaced with the antenna element 1H according to embodiment 2 or any one of the antenna elements 1A to 1G and 1I according to variations 1 to 8. The plurality of antenna elements 1 may be arrayed longitudinally and transversely into a matrix form or in any other manner on the dielectric substrate 10 having a large size for an array.

The antenna substrate 110 may include an electrode 130 connected to an integrated circuit 200 configured to execute at least one of outputting a transmission signal or inputting a reception signal, and a transmission line 120 configured to allow signal transmission between the electrode 130 and each of the antenna elements 1. Part of the transmission line 120 may correspond to the feed conductors 24 of the antenna elements 1.

The antenna substrate 110 may be equipped with a filter circuit configured to extract a signal in a desired frequency band out of signals on the transmission line 120.

The present embodiment provides an antenna module 100 including the antenna substrate 110 and the integrated circuit 200. The integrated circuit 200 may be joined to an opposite side of a radio wave emitting side of the antenna substrate 110.

In the present embodiment, the antenna substrate 110 and the antenna module 100 can execute one or both of transmission of a broadband radio wave and reception of a radio wave. Furthermore, a broadband radio wave can be transmitted to easily add a phase difference to a radio wave transmitted between the plurality of antenna elements 1. Addition of the phase difference enables beam forming of outputting a radio wave in a beam form at a desired angle. In the present embodiment, the antenna substrate 110 and the antenna module 100 can therefore effectively facilitate beam forming.

The embodiments of the present disclosure have been described above. In the present disclosure, the antenna element, the antenna substrate, and the antenna module are not limited to those according to the above embodiments. For example, the feed conductor plate and the nonfeed conductor plate each have a planar surface that may have a polygonal shape other than the rectangular shape, or a shape with an outer line containing a curved line. One or both of the feed conductor plate and the nonfeed conductor plate may include a slit. Furthermore, in the dielectric substrate, the ground conductor and the feed conductor plate or the feed conductor plate and the nonfeed conductor plate may interpose a space such as an air gap. In addition, details exemplified in the embodiments can be appropriately changed without departing from the purport of the present disclosure.

### INDUSTRIAL APPLICABILITY

The present disclosure is applicable to an antenna element, an antenna substrate, and an antenna module.

### REFERENCE SIGNS

1, 1A to 1K antenna element
10 dielectric substrate
11a dielectric layer (first dielectric)
11b dielectric layer (second dielectric)
21 ground conductor
22 feed conductor plate
23 nonfeed conductor plate
24 feed conductor
25, 25H, 25I projecting conductor
25Ha, 25Ia rod-shaped body
25Hb, 25Ib plate-shaped body
E25 end surface
R1, R2 region
s1 first side
s2 second side
100 antenna module
110 antenna substrate
120 transmission line
130 electrode
200 integrated circuit
p1 lower pole frequency
p2 higher pole frequency

1. An antenna element comprising
a first dielectric, a second dielectric, a ground conductor, a feed conductor plate, and a nonfeed conductor plate, wherein
the ground conductor, the feed conductor plate, and the nonfeed conductor plate are positioned in a mentioned order,
the ground conductor and the feed conductor plate face each other to interpose the first dielectric,
the feed conductor plate and the nonfeed conductor plate face each other to interpose the second dielectric, and
the antenna element further comprises a projecting conductor projecting from the feed conductor plate toward the ground conductor.

2. The antenna element according to claim 1, wherein
the projecting conductor includes a rod-shaped body extending in a projecting direction.

3. The antenna element according to claim 2, wherein
the projecting conductor further includes a plate-shaped body connected to the rod-shaped body and expanding in a direction crossing the projecting direction.

4. The antenna element according to claim 1, wherein
in a plan perspective view, the projecting conductor includes an end surface disposed adjacent to the ground conductor and entirely positioned in a region surrounded with an outer edge of the feed conductor plate.

5. The antenna element according to claim 1, wherein
in a plan perspective view, the feed conductor plate includes a first side and a second side crossing a resonant direction,
in a plan perspective view,
the projecting conductor includes an end surface disposed adjacent to the ground conductor and including a center positioned in at least one of inside the first side as well as within a distance L1 from the first side or inside the second side as well as within the distance L1 from the second side, and
the distance L1 is 0.1×an effective wavelength corresponding to a maximum frequency in a transmission frequency band.

6. An antenna substrate comprising
a plurality of antenna elements, wherein
each of the plurality of antenna elements is the antenna element according to claim 1.

7. An antenna module comprising:
the antenna substrate according to claim 6; and
an integrated circuit.
